(19) United States
(12) Patent Application Publication
(10) Pub. No.: US 2019/0329390 A1
(43) Pub. Date: Oct. 31, 2019

(54) NAIL GUN WITH DRY FIRE PREVENTION DEVICE

(71) Applicant: EVERWIN PNEUMATIC CORPORATION, Taichung City (TW)

(72) Inventors: ING-CHIN LIN, Taichung City (TW); JUI-CHANG WANG, Taichung City (TW)

(21) Appl. No.: 15/966,446

(22) Filed: Apr. 30, 2018

(51) Int. Cl. B25C 1/00; B25C 1/04

(52) U.S. Cl. CPC B25C 1/008; B25C 1/047

(57) ABSTRACT

A nail gun with dry fire prevention device includes a gun body, a nail magazine connected with the gun body, a trigger device, and an action assembly. The nail magazine is configured to house at least a nail. The action assembly includes an action member fixed on an outer side of the nail magazine and an operation member pivotally disposed at the action member. The operation member has a first and second portions disposed on two ends of the operation member, respectively. When the nail magazine is empty of the nail, the first portion enters the nail magazine, and the second portion blocks the trigger member, such that the trigger member is unable to be operated. Therefore, the dry fire operation of the nail gun without nails is prevented, improving the convenience of usage and the utility of the nail gun.

### BACKGROUND OF THE INVENTION

### 1. Field of the Invention

The present invention relates to nail gun structures, and more particularly, to a nail gun with dry fire prevention device.

### 2. Description of the Related Art

Upon using a nail gun, the user usually needs a continuous firing function. As a result, the user often pulls the trigger of the nail gun under an empty status of the nail gun, with no nails contained in the nail magazine or inside the nail gun. Also, when the trigger is pulled without any nails being fired, the user sometimes repeatedly pulls the trigger to assure that the nail gun has run out of nails.

However, such accustomed behavior of the user easily causes the firing device of the nail gun being damaged. As a result, the service life of the nail gun is shortened.

### SUMMARY OF THE INVENTION

For improving the issues above, a nail gun with dry fire prevention device is disclosed, which prevents the firing operation from occurring without nails being fired, so as to improve the smoothness of the nail firing operation and the service life of the nail gun.

To achieving the aforementioned objectives, a nail gun with dry fire prevention device in accordance with an embodiment of the present invention is provided, comprising:

a gun body including a firing portion;

a nail magazine connected with the firing portion, the nail magazine housing a nail and providing the nail to the firing portion;

a trigger device disposed on the gun body and provided with a trigger member, the trigger member pivotally disposed on the gun body and controlling the firing of the nail; and

an action assembly disposed on the nail magazine, the action assembly including an action member fixed on an outer side of the nail magazine and an operation member pivotally disposed at the action member, the operation member having a first portion and a second portion disposed on two ends of the operation member, respectively,

wherein when the nail magazine is empty of the nail, the first portion enters the nail magazine, and the second portion is configured to block a movement of the trigger member, such that the trigger member is unable to be operated.

With such configuration, when the nail magazine is empty of nails, the first portion of the operation member pivotally sways into the nail magazine, such that the second portion of the operation member blocks the movement of the trigger member, preventing the trigger member from being operated to cause the nail firing operation. Therefore, the trigger device is not operable with no nails housed in the nail magazine, avoiding the damage upon the trigger device and the nail gun. Thus, the convenience of usage, the utility, and the service life of the nail gun are improved.

### BRIEF DESCRIPTION OF THE DRAWINGS

FIG. 1 is a perspective view of the nail gun in accordance with an embodiment of the present invention.

FIG. 2 is an exploded view of the nail gun in accordance with an embodiment of the present invention.

FIG. 3 is a partially sectional perspective view of the nail gun in accordance with an embodiment of the present invention.

FIG. 4 is a sectional view illustrating the nail gun without a nail housed in the nail magazine.

FIG. 5 is a sectional view illustrating the nail gun with a nail housed in the nail magazine.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

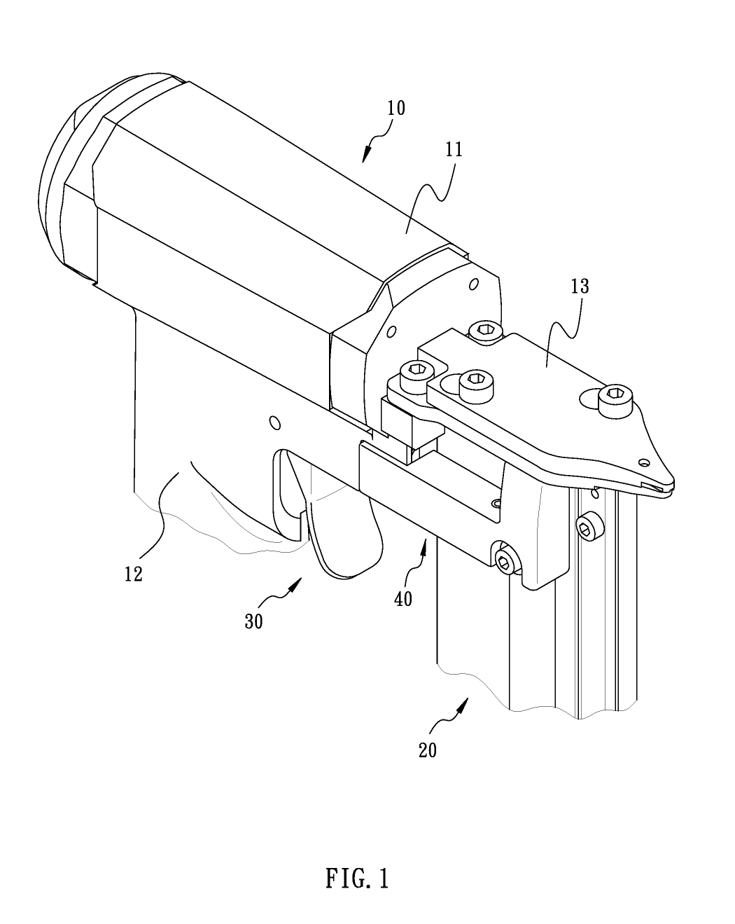

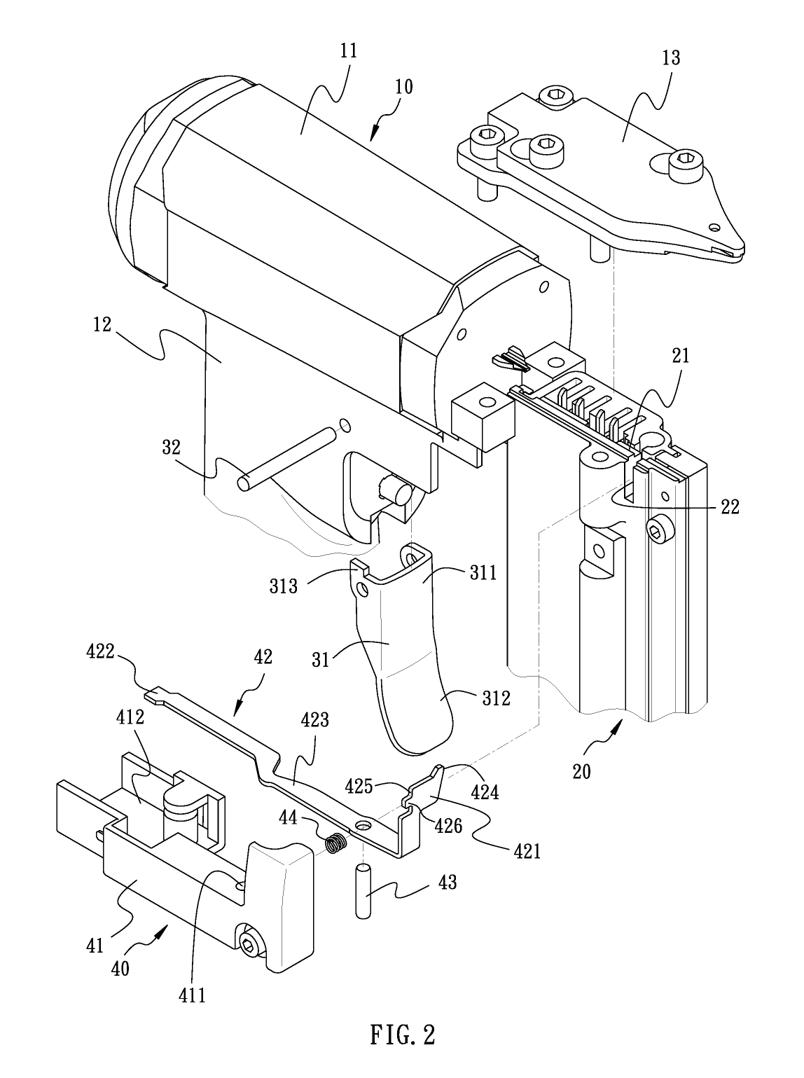

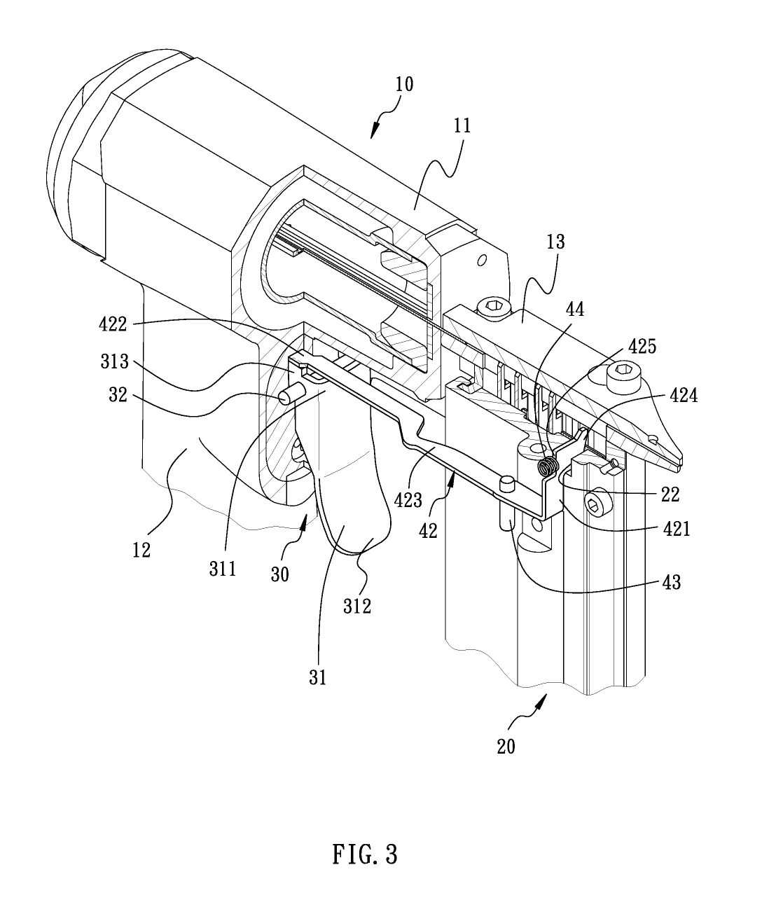

Referring to FIG. 1 to FIG. 5, an embodiment of the present invention discloses a nail gun with dry fire prevention device, comprising a gun body 10, a nail magazine 20, a trigger device 30, and an action assembly 40.

The gun body 10 includes a gun head 11 and a handle 12 connected with the gun head 11, with a cavity formed between the gun head 11 and the handle 12. The cavity is connected with an air pressure source, such that the air pressure source provides a compressed air into the cavity. The gun head 11 has one end thereof provided with a firing portion 13.

The nail magazine 20 is connected with the firing portion 13 of the gun body 10. The nail magazine 20 includes a nail channel 21 disposed therein for containing a nail 1. The nail magazine 20 is allowed to provide the nail 1 to the firing portion 13. In an embodiment of the present invention, a plurality of nails 1 are provided, such that the nail magazine 20 is able to respectively provide each of the nails 1 to the firing portion 13. Further, the nail magazine 20 includes an opening 22 which is connected with the nail channel 21.

The trigger device 30 is disposed at the handle 12 of the gun body 10 and includes a trigger member 31 and a first pivotal connection member 32. The trigger member 31 is pivotally disposed at the handle 12 of the gun body 10 through the first pivotal connection member 32. The trigger member 31 is pressed to be operated, such that the compressed air of the air pressure source enters the cavity and hit the nail 1. As a result, the nail 1 in the firing portion 13 is fired toward the object to enter the object.

Further, the trigger member 31 includes a connection portion 311 and an operation portion 312. The connection portion 311 is pivotally disposed at the handle 12 of the gun body 10 through the first pivotal connection member 32. The operation portion 312 is pressed to connect the air pressure source and the cavity, wherein a block member 313 protrudes from one side of the connection portion 311 toward the gun head 11.

The action assembly 40 is disposed at the nail magazine 20. The action assembly 40 includes an action member 41, an operation member 42, and a second pivotal connection member 43. The action member 41 is fixed at the outer side of the nail magazine 20. The action member 41 includes a through bore 411 and a movement groove 412. The operation member 42 is pivotally disposed in the through bore 411 of the action member 41. The operation member 42 has a first portion 421 and a second portion 422 disposed at two ends of the operation member 42, respectively, with a body portion 423 connected between the first portion 421 and the second portion 422. The body portion 423 is disposed in the movement groove 412, wherein the body portion 423 is pivotally disposed at the action member 41 through the second pivotal connection member 43. The first portion 421 is allowed to enter into the opening 22 of the nail magazine 20. The second portion 422 is allowed to pivotally sway with the second pivotal connection member 43 as the pivoting center, so as to contact or sway away from the block member 313 of the connection portion 311. When the operation member 42 pivotally sways, the body portion 423 sways in the movement groove 412. Also, the first portion 421 is disposed at one side of the body portion 423 and arranged in vertical to the body portion 423, and the second portion 422 is disposed at one side of the body portion 423. In an embodiment of the present invention, the operation member 42 is formed in an approximate L shape.

In addition, the first portion 421 includes a first side 424 and a second side 425. The first side 424 passes through the opening 22. The second side 425 is convexly provided with a protrusion 426. A resilient member 44 is disposed between the action member 41 and the first portion 421 of the operation member 42, such that the resilient member 44 is mounted on the protrusion 426 for pushing the operation member 42 with the prestress of the resilient member 44 which is imposed upon the operation member 42. In an embodiment of the present invention, the resilient member 44 is a compression spring. The resilient member 44 has two ends thereof resting against the action member 41 and the second side 425 of the first portion 421. Normally, the prestress of the resilient member 44 permanently pushes the first portion 421, so that the first side 424 of the first portion 421 passes through the opening 22 and enters the nail channel 21.

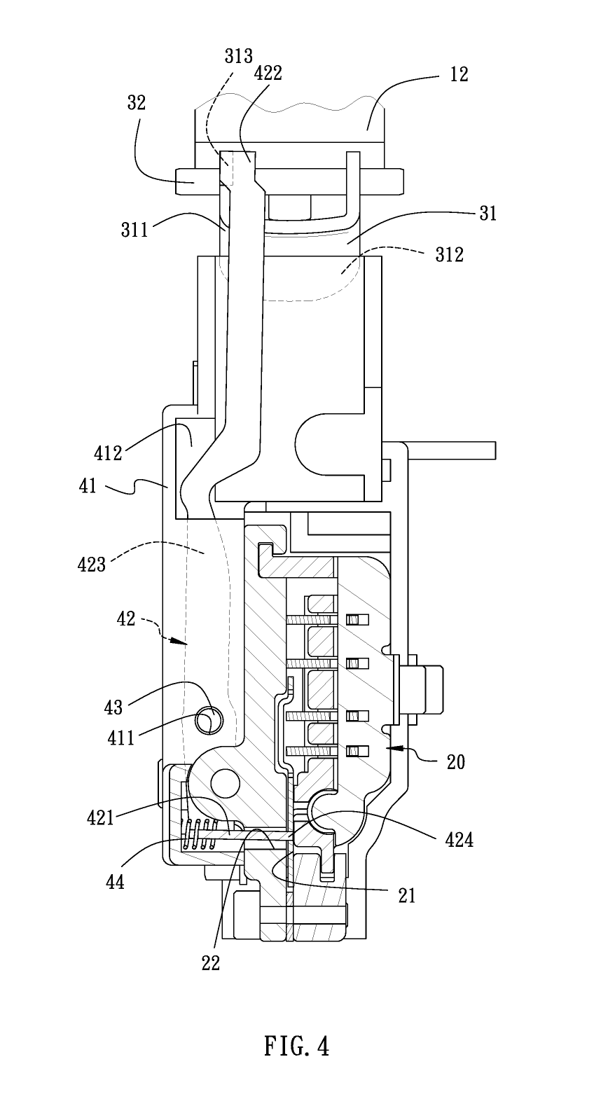

Referring to FIG. 4, when the nail 1 is not present in the nail channel 21 of the nail magazine 20, the prestress of the resilient member 44 pushes the first portion 421, such that the first side 424 of the first portion 421 is inserted into the nail channel 21 via the opening 22, and the second portion 422 is positioned upon the block member 313 of the trigger member 31 to contact the block member 313, achieving a blocking effect. Therefore, the trigger member 31 is unable to be pressed.

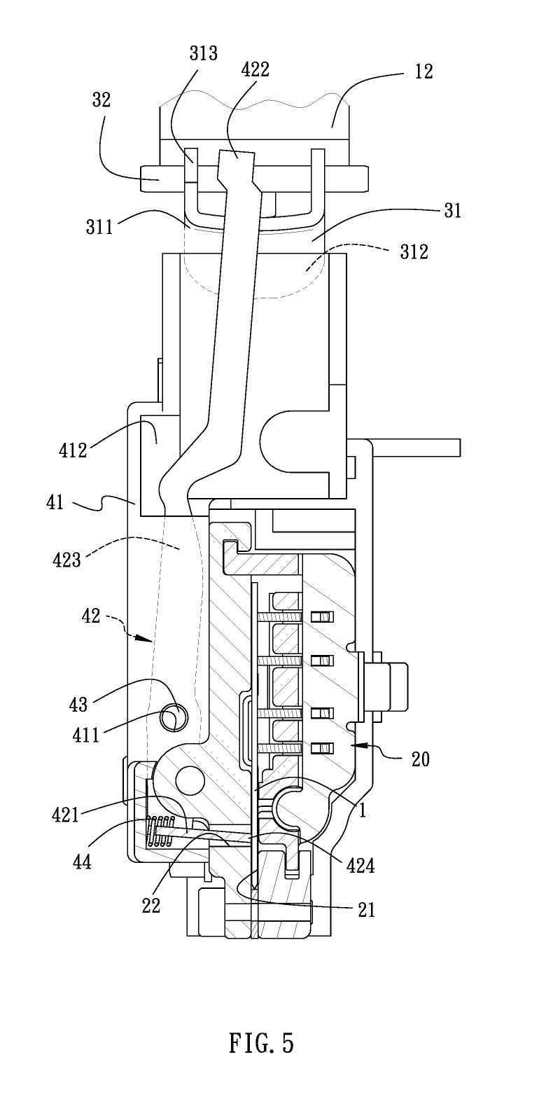

Referring to FIG. 5, when the nail channel 21 of the nail magazine 20 contains a nail 1, the nail 1 pushes the first side 424 of the first portion 421, and the operation member 42 pivotally sways with the second pivotal connection member 43 as the pivoting center, such that the first side 424 of the first portion 421 sways away to leave the nail channel 21 and is retracted into the opening 22. At the same time, the second portion 422 correspondingly sways away from the block member 313 of the trigger member 31, such that the trigger member 31 is no longer blocked by the second portion 422 of the operation member 42. Therefore, the operation portion 312 of the trigger member 31 is allowed to be pressed, such that the air pressure source and the cavity are connected, allowing the compression air to enter the cavity for firing the nail 1 from the firing portion 13 toward the object.

With such simple configuration, the present invention effectively prevents the trigger device 30 to be operated when the nail magazine 20 is empty of the nail 1, thus avoiding the damage caused by dry fire of the nail gun due to a futile operation of the trigger device 30, improving the convenience, the utility, and the service life of the nail gun.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A nail gun with dry fire prevention device, comprising:
a gun body including a firing portion;
a nail magazine connected with the firing portion, the nail magazine configured to house a nail and provide the nail to the firing portion;
a trigger device disposed on the gun body and provided with a trigger member, the trigger member pivotally disposed on the gun body and configured to control a firing operation of the nail; and
an action assembly disposed on the nail magazine, the action assembly including an action member fixed on an outer side of the nail magazine and an operation member pivotally disposed at the action member, the operation member having a first portion and a second portion disposed on two ends of the operation member, respectively,
wherein when the nail magazine is empty of the nail, the first portion enters the nail magazine, and the second portion is configured to block a movement of the trigger member, such that the trigger member is unable to be operated.

2. The nail gun of claim 1, wherein the nail magazine includes a nail channel disposed therein for containing the nail, the nail magazine further including an opening connected with the nail channel, such that the first portion is allowed to be inserted into the nail channel via the opening.

3. The nail gun of claim 2, further comprising a resilient member disposed between the action member and the first portion of the operation member, such that a prestress of the resilient member is imposed upon the operation member.

4. The nail gun of claim 3, wherein the first portion includes a first side and a second side, the first side passing through the opening, the second side convexly provided with a protrusion, such that the resilient member is mounted on the protrusion.

5. The nail gun of claim 1, wherein a body portion is connected between the first portion and the second portion, and the body portion is pivotally disposed at the action member.

6. The nail gun of claim 5, wherein the first portion is disposed at one side of the body portion and arranged in vertical to the body portion, and the second portion is disposed at one side of the body portion.

7. The nail gun of claim 6, wherein the operation member is formed in an L shape.

8. The nail gun of claim 1, wherein the trigger member comprises a connection portion and an operation portion, the connection portion pivotally connected with the gun body, the operation portion configured to be pressed, such that the second portion of the operation member contacts or moves away from the connection portion.

9. The nail gun of claim 8, wherein a block member protrudes from one side of the connection portion, such that the second portion contacts the block member to prevent the trigger member to be operated.

10. A nail gun with dry fire prevention device, comprising:
a gun body including a firing portion;
a nail magazine connected with the firing portion, the nail magazine configured to house a nail and provide the nail to the firing portion;
a trigger device disposed on the gun body and configured to control a firing operation of the nail;
an action assembly disposed on the nail magazine, the action assembly including a first end and a second end disposed in opposite to the first end; and
a resilient member configured to permanently push the first end into the nail magazine, such that the second end rests upon the trigger device and prevents the trigger device to be operated.

11. The nail gun of claim 10, wherein the action assembly includes an action member and an operation member, the action member fixed on an outer side of the nail magazine, the operation member pivotally disposed at the action member, the resilient member disposed between the action member and the operation member, the operation member having a first portion and a second portion disposed at two ends of the operation member, respectively, such that a prestress of the resilient member is imposed upon the first portion, and the second portion contacts the trigger device.
